(19) United States
(12) Patent Application Publication
(10) Pub. No.: US 2014/0013001 A1
(43) Pub. Date: Jan. 9, 2014

(54) PARALLEL PROBING FOR EFFICIENT PROXY SELECTION IN NETWORKED ENVIRONMENTS

(71) Applicants: Matthew R. Cox, Kirkland, WA (US); Eric N. Loewenthal, Seattle, WA (US); Ritika Virmani, Seattle, WA (US); Ivan D. Pashov, Woodinville, WA (US); Jonathan A. Silvera, Seattle, WA (US); Rishi Maker, Redmond, WA (US)

(72) Inventors: Matthew R. Cox, Kirkland, WA (US); Eric N. Loewenthal, Seattle, WA (US); Ritika Virmani, Seattle, WA (US); Ivan D. Pashov, Woodinville, WA (US); Jonathan A. Silvera, Seattle, WA (US); Rishi Maker, Redmond, WA (US)

(73) Assignee: MICROSOFT CORPORATION, Redmond, WA (US)

(21) Appl. No.: 13/543,085

(22) Filed: Jul. 6, 2012

(51) Int. Cl. G06F 15/16

(52) U.S. Cl. 709/230

(57) ABSTRACT

In one or more embodiments, clients in various networks can proactively probe multiple proxies that are returned to the client. Clients can sort the proxies based on various parameters, such as connection time parameters as well as other parameters, and utilize the fastest or one of the fastest proxies available, or select a proxy based on other parameters that indicate the proxy is reliable. In this manner, slow or unreliable proxies can be avoided.

### BACKGROUND

In some computing environments such as various networks, web applications such as web browsers and the like can utilize script to have a list of available proxies returned which, in turn, can be used for a specified URL. The Web Proxy AutoDiscovery (WPAD) protocol is one such protocol, among others, that can be utilized by web clients to search a network to find information about proxies.

Web clients can experience sub-optimal connection times or connectivity loss when proxy candidates for a given URL are unreliable or slow.

### SUMMARY

This Summary is provided to introduce a selection of concepts in a simplified form that are further described below in the Detailed Description. This Summary is not intended to identify key features or essential features of the claimed subject matter.

In one or more embodiments, clients in various networks, such as Web Proxy AutoDiscovery (WPAD) enabled networks as well as others, can proactively probe multiple proxies that are returned to the client. Clients can sort the proxies based on various parameters, such as connection time parameters as well as other parameters, and utilize the fastest or one of the fastest proxies available, or select a proxy based on other parameters that indicate the proxy is reliable. In this manner, slow or unreliable proxies can be avoided.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform the various embodiments described herein.

FIG. 2 illustrates a system in accordance with one or more embodiments.

FIG. 3 is a flow diagram that describes steps in a method in accordance with one or more embodiments.

FIG. 4 illustrates an example proxy grouping in accordance with one or more embodiments.

FIG. 5 illustrates an example system that includes the computing device as described with reference to FIG. 1.

FIG. 6 illustrates various components of an example device that can be implemented as any type of computing device as described herein.

### DETAILED DESCRIPTION

Overview

In a basic WPAD scenario, a client first retrieves a WPAD script from a WPAD server and runs this script, passing the URL of an outgoing HTTP request. The script typically then returns a proxy or a list of proxies that can be utilized by the client. If the script returns a proxy list, the client's HTTP stack will attempt to send its request using the first proxy that appears in the list. If a request with a given proxy fails or hits a timeout, then the HTTP stack will attempt the request using the next proxy in the list. In some instances, the script execution result can contain proxies that are down, overloaded, or malfunctioning If a request is made to a bad proxy, a blocking delay can occur. After the request times out, the client can typically re-issue the request to the next proxy in the list, thus resulting in a perceptible delay. This can occur for both bad proxies or slow proxies.

In one or more embodiments, clients in various networks, such as Web Proxy AutoDiscovery (WPAD) enabled networks as well as others, can proactively probe multiple proxies that are returned to the client. Clients can sort the proxies based on various parameters, such as connection time parameters as well as other parameters, and utilize the fastest or one of the fastest proxies available, or select a proxy based on other parameters that indicate the proxy is reliable. In this manner, slow or unreliable proxies can be avoided.

In the examples used in this document, a WPAD-enabled network is used. It is to be appreciated and understood, however, that other types of networks other than WPAD-enabled networks can be utilized without departing from the spirit and scope of the claimed subject matter. For example, a client may be configured to use a hard coded proxy, as in corporate environments. Here, the proxy name could resolve to multiple IP addresses. In these instances, the techniques described herein can be applied to the multiple IP addresses.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

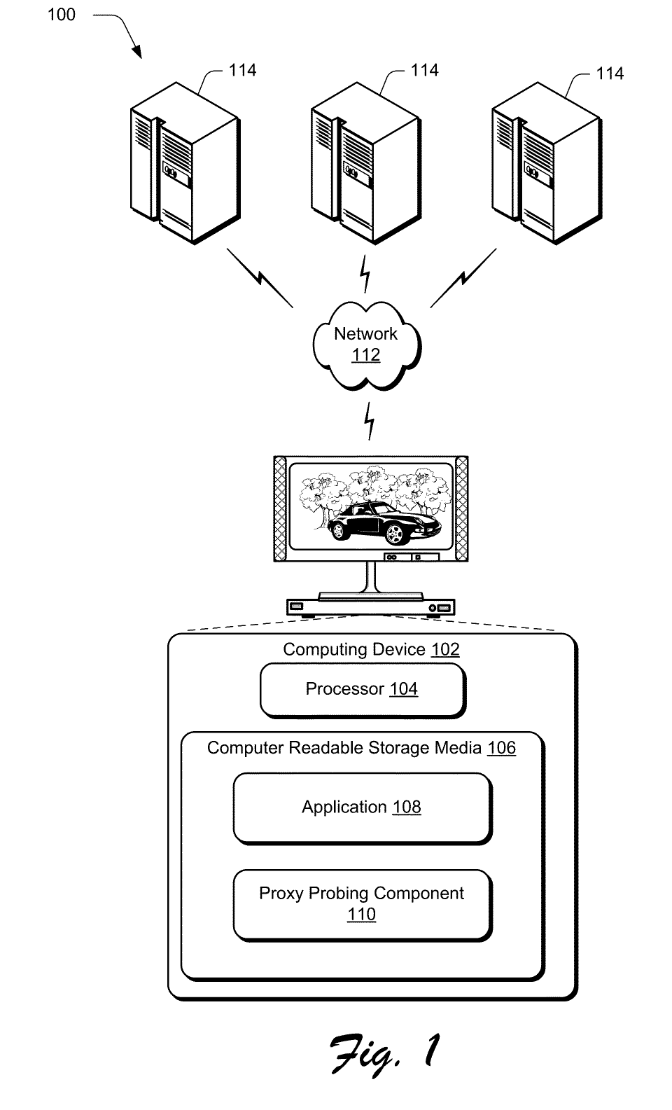

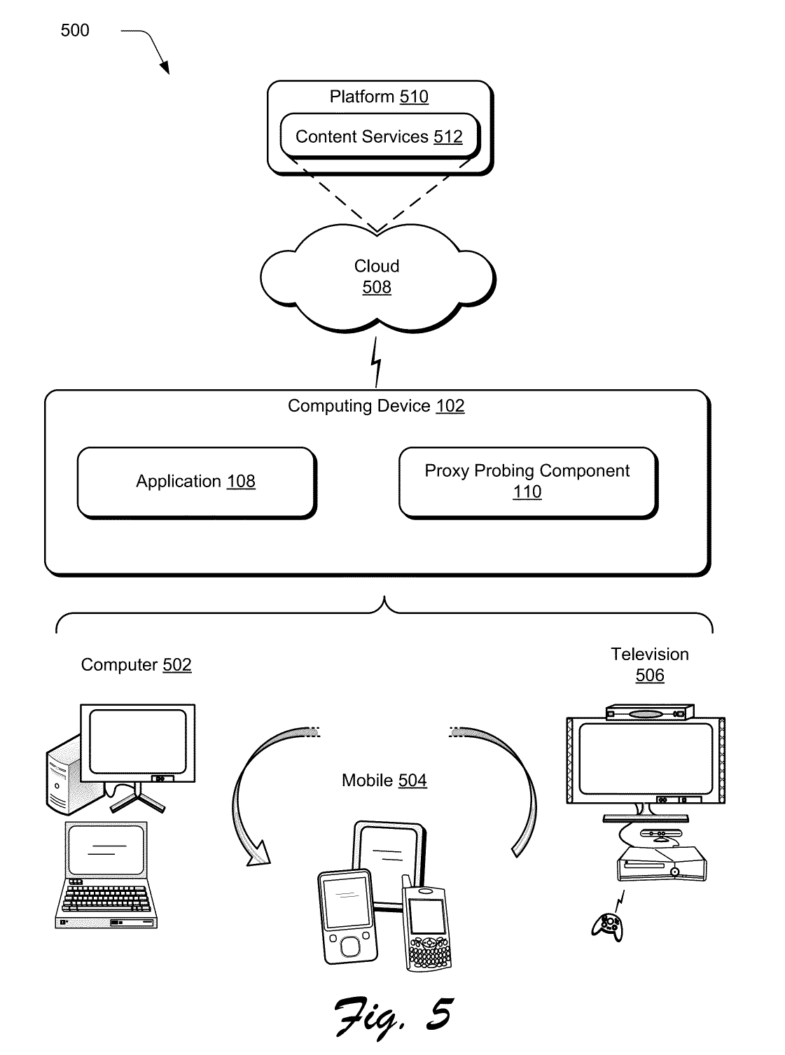

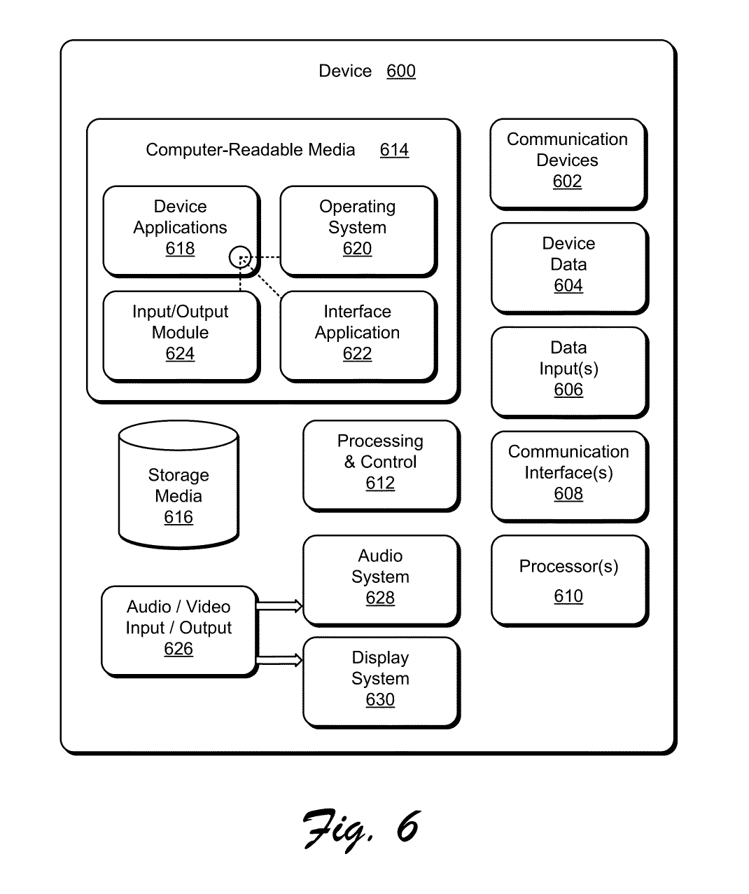

FIG. 1 illustrates an operating environment in accordance with one or more embodiments, generally at 100. Environment 100 includes a computing device 102 in the form of a local client machine having one or more processors 104, one or more computer-readable storage media 106, and one or more applications 108 that resides on the computer-readable storage media and which are executable by the processor 104. Computing device 102 also includes a proxy probing component 110 that operates as described below. The proxy probing component can comprise part of the client device's HTTP stack or a separate component that is utilized by the HTTP stack. Computing device 102 can be embodied as any suitable computing device such as, by way of example and not limitation, a desktop computer, a portable computer, a handheld computer such as a personal digital assistant (PDA), mobile phone, television, tablet computer, and the like. Varieties of different examples of a computing device 102 are shown and described below in FIGS. 5 and 6.

Applications 108 can include any suitable type of applications including, by way of example and not limitation, a web browser and/or various other web applications. The web browser is configured to navigate via the network 112. Although the network 112 is illustrated as the Internet, the network may assume a wide variety of configurations. For example, the network 112 may include a wide area network (WAN), a local area network (LAN), a wireless network, a public telephone network, an intranet, and so on. Further, although a single network 112 is shown, the network 112 may be configured to include multiple networks.

The browser, for instance, may be configured to navigate via the network 112 to interact with content available from one or more web servers 114 as well as communicate data to the one or more web servers 114, e.g., perform downloads and uploads. The web servers 114 may be configured to provide one or more services that are accessible via the network 112. Examples of such services include email, web pages, photo sharing sites, social networks, content sharing services, media streaming services, and so on. In at least some embodiments, one or more of the servers may be configured as a server from which a list of proxies can be retrieved. One example of such a server is a WPAD server.

One or more of the applications 108 may also be configured to access the network 112, e.g., directly themselves and/or through the browser (in the event an application 108 is not a web browser). For example, one or more of the applications 108 may be configured to communicate messages, such as email, instant messages, and so on. In additional examples, an application 108, for instance, may be configured to access a social network, obtain weather updates, interact with a bookstore service implemented by one or more of the web servers 114, support word processing, provide spreadsheet functionality, support creation and output of presentations, and so on.

Thus, applications 108 may also be configured for a variety of functionality that may involve direct or indirect network 112 access. For instance, the applications 108 may include configuration settings and other data that may be leveraged locally by the application 108 as well as synchronized with applications that are executed on another computing device. In this way, these settings may be shared by the devices. A variety of other instances are also contemplated. Thus, the computing device 102 may interact with content in a variety of ways from a variety of different sources.

In operation, when a client on computing device 102 executes a script, e.g., a WPAD script, and a proxy list is returned, the client will issue, through proxy probing component 110, parallel requests to the various proxies. Other techniques can be utilized to receive a list of proxies. These other techniques include those that do not utilize WPAD techniques. The requests can comprise any suitable request that causes the proxies to take some kind of action from which the client can ascertain the desirability of using particular proxies. In at least some embodiments, these requests are in the form of HTTP Head Requests. Other types of requests can be issued without departing from the spirit and scope of the claimed subject matter. The client will then record parameters associated with the action undertaken by the proxies. For example, the client may record the number of hops, load on the server, and the like to ascertain the best proxy. In this specific example, the action undertaken by the proxies involves sending a response to the client. As such, the response times for all the parallel requests are recorded and the proxy list is re-sorted from the fastest response time to the slowest response time and, if present, may remove non-responsive proxies. The client will then use the new proxy list order when attempting to send an HTTP Request. Using this approach, the client will not attempt to use a bad proxy, as determined during the probing time. This can reduce or eliminate delays waiting for the request to timeout, which can be in the order of seconds. In addition, the client can use the proxy with fastest response time, thus reducing or eliminating perceived delays due to the previous approaches of serially progressing through proxies that appear in the originally-received list.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware or virtual machines of the computing device 102 to perform operations, e.g., processors, functional blocks, and so on. For example, the computing device 102 may include a computer-readable medium that may be configured to maintain instructions that cause the computing device, and more particularly the operating system and associated hardware of the computing device 102 to perform operations. Thus, the instructions function to configure the operating system and associated hardware to perform the operations and in this way result in transformation of the operating system and associated hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having described an example environment in which the techniques described herein may operate, consider now a discussion of some example embodiments that can utilize the principles described herein.

Example Embodiments

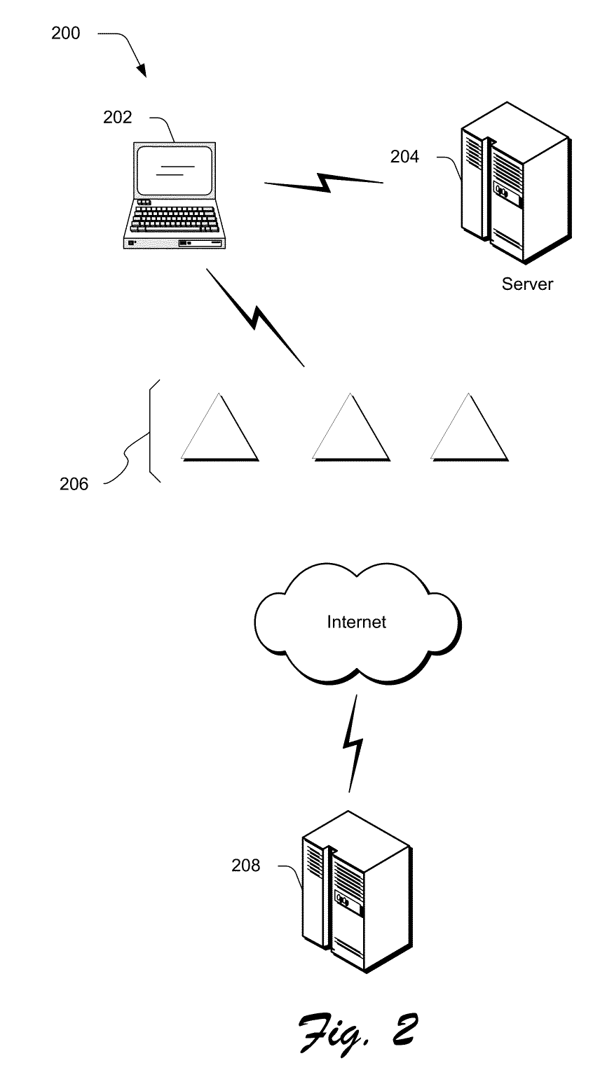

FIG. 2 illustrates a system in accordance with one or more embodiments generally at 200. In this example, system 200 includes a client device 202, a server 204 which, in this example, comprises a WPAD server. WPAD is used as an example and, as such, is not to be construed as limiting the claimed subject matter. The system also includes a plurality of proxies shown generally at 206. Any suitable number of proxies can be utilized and can comprise any suitably-configured proxy that can enable access to the Internet and, thereafter, one or more servers. An example server is illustrated at 208.

In the illustrated and described example, client device 202 utilizes discovery techniques to locate a URL of a configuration file. This can be done using any suitable technique, examples of which include Dynamic Host Configuration Protocol (DHCP) or Domain Name System (DNS) discovery techniques to ascertain the location of the configuration file. Once detection and download of the configuration file is complete, it can be executed to determine one or more proxies for a specified URL.

In this specific example, client device 202 executes a script, e.g., a WPAD script, and a proxy list is returned from server 204. The client device, uses its HTTP stack, e.g., via proxy probing component 110 (FIG. 1), to issue parallel probing requests to the various proxies shown generally at 206. In at least some embodiments, these requests are in the form of HTTP Head Requests. Other types of requests can be issued without departing from the spirit and scope of the claimed subject matter. For example, other protocols could be utilized to formulate the parallel requests. The client device will then record the response times or other information for all the parallel requests and re-sort the proxy list from the fastest response time to the slowest response time and, if present, may remove non-responsive proxies. The client device will then use the new proxy list order when attempting to send an HTTP Request. Using this approach, the client will not attempt to use a bad proxy, as determined during the probing time. This can reduce or eliminate delays waiting for the request to timeout, which can be in the order of seconds. In addition, in at least some embodiments, the client can use the proxy with fastest response time, thus reducing or eliminating perceived delays due to the previous approaches of serially progressing through proxies that appear in the originally-received list.

Parallel probing of the various proxies can take place in any suitable way using, for example, any suitable time-based or functional-based processing techniques. For example, in the approach described above, an HTTP request is sent in parallel to all of the proxies. When the HTTP request is sent to the proxies, a timer is started and the time that it takes to receive a response from each proxy is logged. The proxy list is then sorted based upon the logged time for each proxy, with the fastest proxies being re-sorted to the top of the list. Based on the sorting, the client device can select the fastest or one of the fastest proxies to issue its HTTP request.

Alternately or additionally, parallel probing of the various proxies can take place by communicating with the proxies and ascertaining TCP connection times associated with each proxy. Based on the TCP connection times, the proxy list can be re-sorted by moving the proxies with the fastest TCP connection times to the top of the list. Based on the sorting, the client device can select the fastest or one of the fastest proxies to issue its HTTP request.

In at least some embodiments, multiple different parameters can be utilized to process the proxy list in order to identify one or more of the fastest proxies. For example, in one approach, the client device can evaluate the TCP connection times of each proxy and, in conjunction with this evaluation, can issue an HTTP request in parallel to multiple proxies that connect. Based on the response times to the HTTP request, the client device can then select the fastest or one of the fastest proxies to issue its subsequent HTTP request.

Alternately or additionally, the probing request from the client device to the various proxies can be issued in parallel and ask each proxy to connect to a known entity over the Internet. Any suitable known entity can be utilized. For example, the entity can comprise a well-known host. If the connection is established with the well-known host and conveyed back to the client device, the proxy list can then be re-sorted based on the connectivity parameters over the Internet. This approach can also enable the client device to ascertain which of the proxies has an Internet connection that is viable.

Having considered an example system in accordance with one or more embodiments, consider now an example method in accordance with one or more embodiments.

Example Method

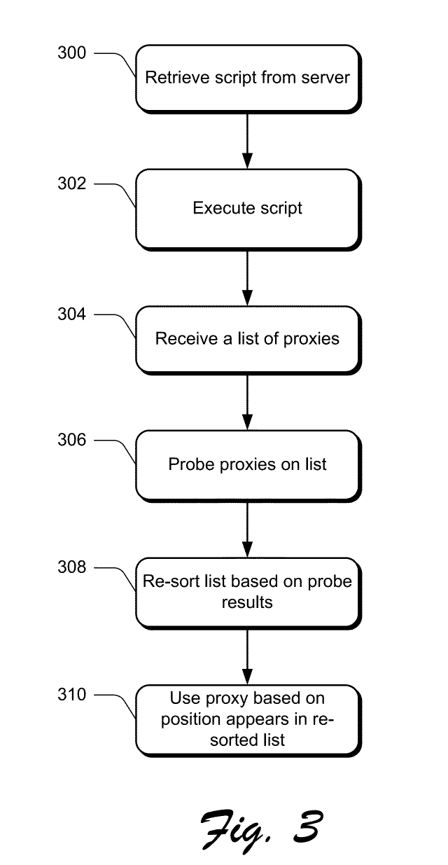

FIG. 3 is a flow diagram that describes steps in a method in accordance with one or more embodiments. The method can be implemented in connection with any suitable hardware, software, firmware, or combination thereof. In at least some embodiments, the method can be implemented by a suitably-configured client device that includes, among other components, a proxy probing component 110 (FIG. 1).

Step 300 receives a script from a server, such as a WPAD server. This step can be performed in any suitable way. Step 302 executes the script and, responsively, step 304 receives a list of proxies. As noted above, other techniques can be utilized to receive a list of proxies including those other than WPAD techniques. Step 306 probes the proxies on the list. In at least some embodiments, probing of the proxies can be conducted in parallel using any suitable techniques. For example, in at least some embodiments, a request can be sent to each proxy and the time that it takes each proxy to respond can be logged. Alternately or additionally, TCP connection times associated with each proxy can be ascertained. Alternately or additionally, each proxy can be probed to ascertain whether each can connect to a known entity over the Internet and if so, the time taken to form the connection.

Based on one or more of the above probing results, step 308 re-sorts the proxy list. Re-sorting the proxy list can enable the faster proxy or proxies, or more reliable proxies to be identified. Once identified, step 310 can utilize a proxy based on the position that it appears in the re-sorted list to send subsequent HTTP requests. This step can be performed in any suitable way. For example, the fastest proxy may be selected for subsequent HTTP request. Alternately, one of the fastest proxies may be selected and need not necessarily be the fastest one that appears in the list. Alternately, parameters other than time-based parameters can be utilized to select a proxy.

Having considered an example method in accordance with one or more embodiments, consider now the notion of grouping proxies in groups.

Grouping Proxies

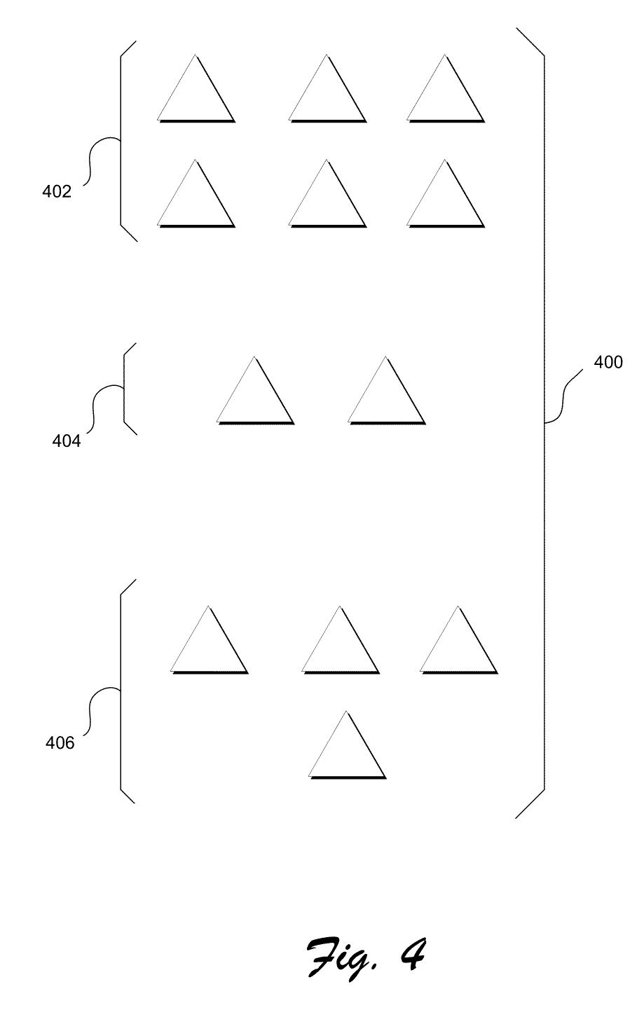

In one or more embodiments, the probing results from probing the proxies in parallel can be utilized to re-sort the proxy list and group various proxies into different groups based upon the relevant parameters such as, by way of example and not limitation, various connection or response times, an ability to connect with a known entity is over the Internet, and the like. Based on the re-sorted proxy list, a proxy from a particular group can be selected for use in subsequent HTTP requests. As an example, consider FIG. 4.

There, the probing results have been utilized to re-sort the proxy list into a collection of groups shown generally at 400. The collection of groups includes three different groups 402, 404, and 406. Group 402 includes six proxies, group 404 includes two proxies, and group 406 includes four proxies. In this example, assume that the groupings are based on response times to a request issued by the client device. Assume also, in this example, that group 402 includes proxies that responded within a first time range, group 404 includes proxies that responded within a second time range, and group 406 includes proxies that responded within a third time range. Assume also that the first time range is the fastest of the three-time ranges. Using this information, the client device can now select a proxy from group 402 to use in its subsequent HTTP requests. Using this approach, as will be appreciated, can facilitate load balancing across proxies that appear within a common group. This approach can also, to a certain extent, attempt to preserve the order in which the proxies appeared in the proxy list that was returned from the server where appropriate. Time ranges can be selected such that proxies that appear within a certain time range are considered to be generally equivalent in terms of their ability to timely handle subsequent HTTP requests.

Non-Blocking

In at least some embodiments, re-sorting of the proxy list can be conducted in a manner which does not block subsequent HTTP requests. For example, in these embodiments, if processing of the proxy list for purposes of re-sorting is not accomplished by the time the web browser wishes to issue an HTTP request, the HTTP request can be allowed to proceed using the first proxy that appears in the un-sorted proxy list that is returned. Once the sorting process has been completed, as described above, proxies that appear on the re-sorted list can be utilized for HTTP requests that follow.

Example System and Device

FIG. 5 illustrates an example system 500 that includes the computing device 102 as described with reference to FIG. 1. The example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 502, mobile 504, and television 506 uses. Each of these configurations includes devices that may have generally different constructs and capabilities, and thus the computing device 102 may be configured according to one or more of the different device classes. For instance, the computing device 102 may be implemented as the computer 502 class of a device that includes a personal computer, desktop computer, a multi-screen computer, laptop computer, netbook, and so on. Each of these different configurations may employ the techniques described herein, as illustrated through inclusion of the application 108 and proxy probing component 110.

The computing device 102 may also be implemented as the mobile 304 class of device that includes mobile devices, such as a mobile phone, portable music player, portable gaming device, a tablet computer, a multi-screen computer, and so on. The computing device 102 may also be implemented as the television 506 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 508 includes and/or is representative of a platform 510 for content services 512. The platform 510 abstracts underlying functionality of hardware (e.g., servers) and software resources of the cloud 508. The content services 512 may include applications and/or data that can be utilized while computer processing is executed on servers that are remote from the computing device 102. Content services 512 can be provided as a service over the Internet and/or through a subscriber network, such as a cellular or Wi-Fi network.

The platform 510 may abstract resources and functions to connect the computing device 102 with other computing devices. The platform 510 may also serve to abstract scaling of resources to provide a corresponding level of scale to encountered demand for the content services 512 that are implemented via the platform 510. Accordingly, in an interconnected device embodiment, implementation of functionality described herein may be distributed throughout the system 500. For example, the functionality may be implemented in part on the computing device 102 as well as via the platform 510 that abstracts the functionality of the cloud 508.

FIG. 6 illustrates various components of an example device 600 that can be implemented as any type of computing device as described with reference to FIGS. 1 and 5 to implement embodiments of the techniques described herein. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of the techniques described herein. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager (e.g., a control application, software application, signal processing and control module, code that is native to a particular device, a hardware abstraction layer for a particular device, etc.). The device applications 618 also include any system components or modules to implement embodiments of the techniques described herein. In this example, the device applications 618 include an interface application 622 and an input/output module 624 that are shown as software modules and/or computer applications. The input/output module 624 is representative of software that is used to provide an interface with a device configured to capture inputs, such as a touchscreen, track pad, camera, microphone, and so on. Alternatively or in addition, the interface application 622 and the input/output module 624 can be implemented as hardware, software, firmware, or any combination thereof Additionally, the input/output module 624 may be configured to support multiple input devices, such as separate devices to capture visual and audio inputs, respectively.

Device 600 also includes an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

Conclusion

In one or more embodiments, clients in various networks, such as Web Proxy AutoDiscovery (WPAD) enabled networks as well as others, can proactively probe multiple proxies that are returned to the client. Clients can sort the proxies based on various parameters, such as connection time parameters as well as other parameters, and utilize the fastest or one of the fastest proxies available, or select a proxy based on other parameters that indicate the proxy is reliable. In this manner, slow or unreliable proxies can be avoided.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A computer-implemented method comprising:
probing multiple proxies on a list of proxies that is returned to a computing device;
re-sorting the proxy list to enable faster or more reliable proxies to be identified, based on said probing; and
utilizing a proxy based on its position in a re-sorted proxy list to send an HTTP request.

2. The method of claim 1, wherein said probing comprises using at least one technique that is not a time-based technique.

3. The method of claim 1, wherein said probing comprises using one or more time-based processing techniques.

4. The method of claim 1, wherein said probing comprises using one or more time-based processing techniques, one of the time-based processing techniques comprising sending an HTTP Head Request to the proxies.

5. The method of claim 1, wherein said probing comprises using one or more time-based processing techniques, one of the time-based processing techniques comprising utilizing TCP connection times associated with each proxy.

6. The method of claim 1, wherein said probing comprises using one or more time-based processing techniques, one of the time-based processing techniques comprising sending an HTTP Head Request to the proxies, another of the time-based processing techniques comprising utilizing TCP connection times associated with each proxy.

7. The method of claim 1 further comprising, prior to probing, receiving the list of proxies from a WPAD server.

8. The method of claim 1, wherein said utilizing comprises utilizing one of the fastest proxies in the re-sorted proxy list.

9. The method of claim 1, wherein said re-sorting comprises re-sorting the proxies into different groups based on one or more parameters; and
said utilizing comprises selecting a proxy from a particular group.

10. One or more computer-readable storage media embodying computer readable instructions, which, when executed, implement a method comprising:
receiving a list of proxies from a server;
probing proxies that appear on the list of proxies utilizing one or more time-based processing techniques;
re-sorting the list of proxies based on probing results; and
utilizing a proxy based on its position in a re-sorted proxy list to send an HTTP request.

11. The one or more computer-readable storage media of claim 10, wherein one of the time-based processing techniques comprises sending an HTTP Head Request to the proxies.

12. The one or more computer-readable storage media of claim 10, wherein one of the time-based processing techniques comprises utilizing TCP connection times associated with each proxy.

13. The one or more computer-readable storage media of claim 10, wherein one of the time-based processing techniques comprises sending an HTTP Head Request to the proxies and another of the time-based processing techniques comprises utilizing TCP connection times associated with each proxy.

14. The one or more computer-readable storage media of claim 10, wherein said probing further comprises requesting each proxy to connect to a known entity over the Internet.

15. The one or more computer-readable storage media of claim 10, wherein said utilizing comprises utilizing the fastest proxy in the re-sorted proxy list.

16. The one or more computer-readable storage media of claim 10, wherein said utilizing comprises utilizing one of the fastest proxies in the re-sorted proxy list.

17. The one or more computer-readable storage media of claim 10, wherein said re-sorting comprises re-sorting the proxies into different groups based on one or more parameters; and
said utilizing comprises selecting a proxy from a particular group.

18. A system comprising:
one or more computer readable storage media;
computer-readable instructions embodied on the one or more computer readable storage media which, when executed, implement a system comprising:
a proxy probing component configured to issue parallel requests to multiple proxies and determine, through time-based processing techniques, one or more fastest proxies to utilize to issue HTTP requests to a server.

19. The system of claim 18, wherein the proxy probing component is configured to receive a sorted list of proxies from a WPAD server and re-sort the list using the time-based processing techniques.

20. The system of claim 18, wherein the proxy probing component is configured to receive a sorted list of proxies from a WPAD server and re-sort the list using the time-based processing techniques, the time-based processing techniques including one or more of the following: using response times to an issued HTTP Head Request issued in parallel to proxies that appear on the sorted list; or using TCP connection times associated with each proxy that appears on the sorted list.
